(19) United States
(12) Patent Application Publication
(10) Pub. No.: US 2010/0161815 A1
(43) Pub. Date: Jun. 24, 2010

(54) MAINTENANCE SYSTEM

(75) Inventor: Jouni Pettissalo, Vaasa (FI)

Correspondence Address: YOUNG & THOMPSON, 209 Madison Street, Suite 500, Alexandria, VA, 22314, US

(73) Assignee: PETTIS OY, Vaasa (FI)

(21) Appl. No.: 12/689,489

(22) Filed: Jan. 19, 2010

Related U.S. Application Data
(63) Continuation of application No. PCT/FI2008/050437, filed on Jul. 17, 2008.

(30) Foreign Application Priority Data
Jul. 17, 2007 (FI) 20075546

(51) Int. Cl. G06F 15/16

(52) U.S. Cl. 709/228

(57) ABSTRACT

A system for maintaining remotely an electric operation equipment. The user has a local terminal to be connected to the operation equipment, from which terminal a wireless connection can be established to the Internet and through it to a remote terminal, which is in use by an expert. The local terminal is provided with a transmission program, by which data can be transferred both between the local terminal and operation equipment and between the local terminal and remote terminal. For the program-based treatment of the operation equipment there is a maintenance program in the remote terminal, local terminal or some server. When a request comes from a user, the expert does the needed treatment via the maintenance program. The expert can ponder the situation and take necessary action without visiting the position of the operation equipment.

The invention relates to a system for maintaining remotely an electric operation equipment. The system comprises both an arrangement and the method based on it.

The operation equipment means in this application a device connected locally to the basic equipment of a process, by means of which device said process is monitored or controlled. The technique for example of an electric power plant, a water supply plant, a sewage disposal system, an industrial plant, a hospital or another large property can be the case. The operation equipment is then e.g. a meter of the energy consumption in an electric power plant or a flow meter in a pumping station.

The operation equipments are increasingly processor-based and thus function by a program. They can include a keyboard and display of their own, by means of which the user can carry out relatively simple operations, such as reading and setting the parameters used the program of the operation equipment. The operation equipment can also include an interface for communicating with it, to which interface the user can connect a separate terminal device. The interface can be for example a traditional serial port or a USB interface. By means of such a near terminal device, or local terminal, the user further can e.g. update the whole software of the operation equipment, when needed.

A connection to many operation equipments can be established also from a terminal of the remote maintenance, or remote terminal, through the communication network. Such a connection can be fully wired or partly wireless. In the latter case e.g. a GSM/GPRS-modem (Global System for Mobile telecommunications/General Packet Radio Service) has been integrated to the operation equipment, from which modem a wireless connection is constituted to the nearest base station. From the publication US 2004/0122908 is known such a maintenance system using network connection. There is established a connection through the Internet from a ‘diagnosing’ device to the operation equipment, or to a PC apparatus, to which the operation equipment has been connected. The system is automatic in that the software of the diagnosing remote device establishes from time to time the connection and communicates with the maintenance program in the operation equipment. A drawback of the system is that the maintenance operations are limited to those, which each time are programmed in the devices in question.

In an advanced system the dealing with the problem situations, regular maintenance and continuous monitoring of the critical data may be implemented from a remote terminal, in certain respects. For this aim a connection can be established between the remote terminal and operation equipment through the network, along which connection information can be transferred to both directions. In addition to the routine operation there is the dealing with the problem situations. If the user or users of a plant do(es) not succeed on the spot to clear up a fault arised or another problem, he can notify the remote maintenance of the matter. An expert standing there starts the connection establishing through the network and clears up the reason of the problem on grounds of the information provided from the operation equipments. This kind of exhaustive and versatile system naturally causes remarkable costs to its user.

However, the operation equipment often lack the program ability e.g. for that its software would be updated remotely through the network. An acute need for updating can arise so that the software of the operation equipment gets to an erroneous state for an internal reason of the system or a wrong keying done by the user. In this case the communication with the operation equipment, relating to the maintenance, has to be carried out locally, and it requires usually an expert in order to succeed. This is a flaw, because the visit of an expert takes time and causes remarkable costs.

The object of the invention is to implement a maintenance system, which uses a remote connection, by a new and advantageous manner. The arrangement according to the invention is characterized in what is set forth in the independent claim 1, and the method according to the invention is characterized in what is set forth in the independent claim 9. Some preferred embodiments of the invention are set forth in the other claims.

The basic idea of the invention is the following: The user of an operation equipment has a local terminal to be connected to the operation equipment, from which terminal a wireless connection can be established to the Internet and through it to a remote terminal, which is in use for an expert of the operation equipment. The local terminal is provided with a transmission program, by which program data can be transferred both between the local terminal and operation equipment and between the local terminal and remote terminal. For the program-based treatment of the operation equipment there is a maintenance program in the remote terminal, local terminal or some server. By means of the maintenance program, when a request has been come from a user, the expert transfers data from the operation equipment, examines the situation, processes the data and sends it back to the operation equipment.

The invention has the advantage that in the problems concerning the operation equipment an expert is attained to ponder the situation and to take necessary action without need to visit physically the position of the operation equipment. The utilizing of a remote expert succeeds, although the operation equipment itself would not include the ability for establishing a maintenance connection through the network. In addition, the invention has the advantage that costs of a system according to it are relatively low.

In the following, the invention will be described in more detail. Reference will be made to the accompanying drawings, in which

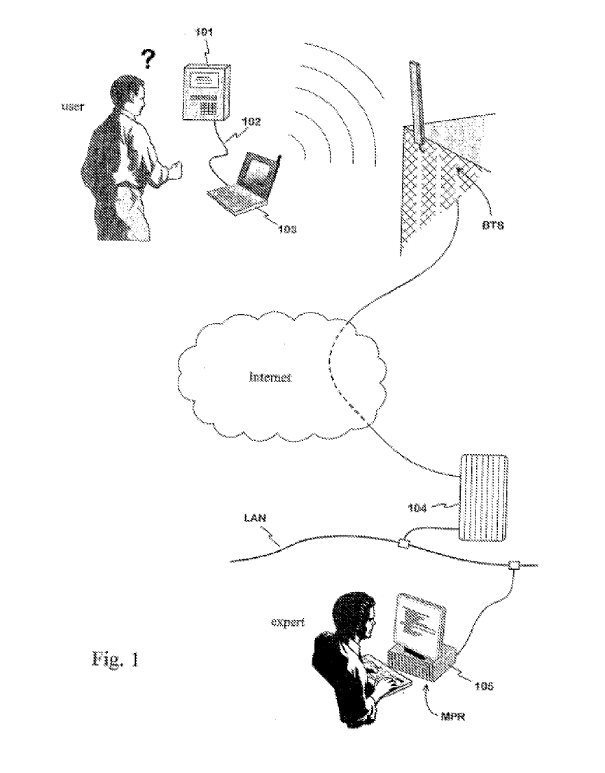

FIG. 1 shows an example of the arrangement according to the invention,

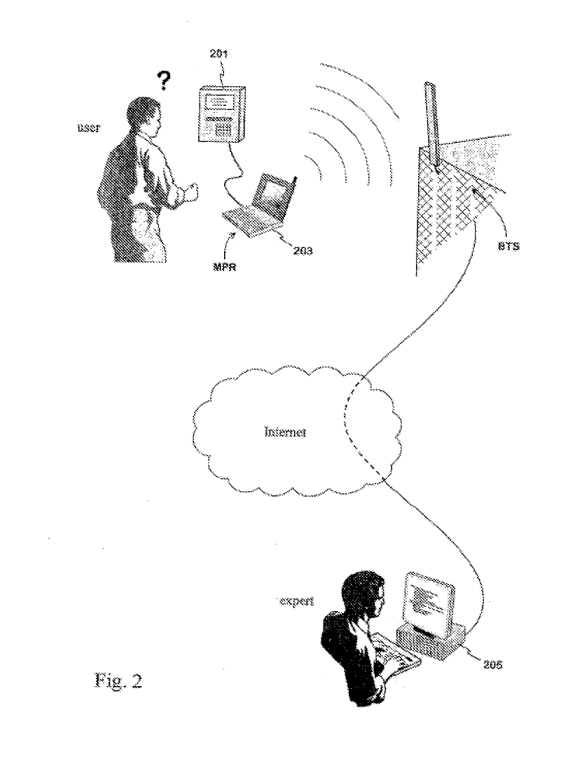

FIG. 2 shows another example of the arrangement according to the invention, and

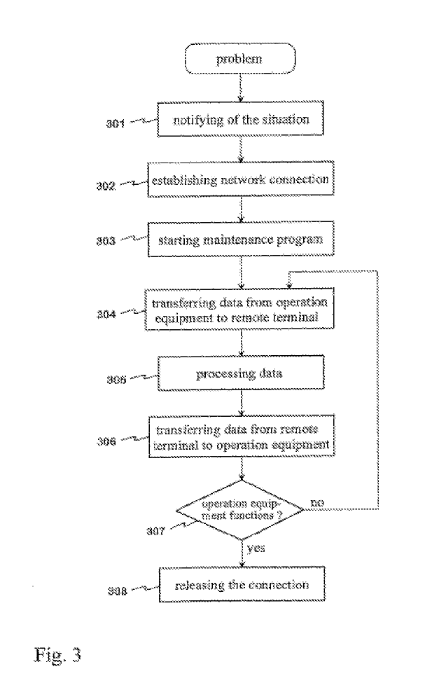

FIG. 3 shows as a flow diagram an example of the method according to the invention.

In FIG. 1 there is seen i.a. an operation equipment 101, a local terminal 103, a base station BTS of a mobile communication network and a remote terminal 105. The operation equipment comprises a relatively simple keyboard and display of its own. The remote terminal is in this example connected to a local area network LAN, which comprises also a server 104. The local terminal 103 is in this example a portable PC. It can be also e.g. a smart phone or a PDA (Personal Digital Assistant). Between the local terminal and operation equipment there is a connection, which uses the interfaces in the operation equipment and local terminal and has a relatively short cable 102 as a transmission path. There is also a connection from the local terminal to the base station, which connection is wireless, of course. The base station again is connected to the Internet for example through a GPRS node. Also the server 104 is connected to the Internet through itd gateway, a connection then can be established between the remote terminal 105 and local terminal. The Internet portion of this connection is drawn by a dashed line in FIG. 1.

The drawing presents a situation where a user, which is uninitiated in the field of the programming technique, has a problem in respect of the operation equipment 101. For this reason he has connected the local terminal 103 to the operation equipment and contacted the quarter, which is responsible for the maintenance of the operation equipment in question. The contact may have been carried out by calling with a phone or by sending a mail from the local terminal. He also sets the local terminal to the communication state, in which it can transfer data both between the local terminal and operation equipment and between the local terminal and a computer in the other end of a network connection. The remote terminal 105 is located in the premises of the quarter, which is responsible for the maintenance and is e.g. the manufacturer or importer of the operation equipment. There is most the time present at least one expert for maintenance service of the operation equipments in question. When the expert listens the account of the user or sees the mail sent by the user, he starts establishing of the network connection from his computer 105, which is said remote terminal, to the local terminal 103 of the user. In addition, he can start the maintenance program MPR of the operation equipment in question in his computer, by which program the software of the operation equipment can be processed, as setting the operation parameters in the software of the operation equipment and/or reading data collected by it for analyzing. Also the whole software can be updated when needed. The maintenance program itself is located either in the remote terminal 105 or in the server 104. Also other data related to the maintenance of the operation equipment in question can be in the server. The process naturally requires the transfer of the desired data from the operation equipment to the remote terminal and the transfer of the processed data in the reverse direction to the operation equipment.

In a second example of the arrangement according to the invention, the arrangement comprises, as above, a server to be used for the maintenance of the operation equipment, but it is located in a third place. In this case the server can be owned e.g. by a network operator or another outside quarter, which offers resources for data storing and processing. The connection of the remote terminal to the Internet can be wired or wireless through a node of a mobile communication network. During the maintenance function of the operation equipment it is established a connection from the remote terminal both to the server and local terminal.

FIG. 2 shows a third example of the arrangement according to the invention. An operation equipment 201, a local terminal 203, a base station BTS of a mobile communication network and a remote terminal 205 are in the figure, as in FIG. 1. In this example, the maintenance program MPR of the operation equipment is located in the local terminal 203 instead the remote terminal. Such an arrangement is feasible especially when the quarter, which is responsible for the maintenance of the operation equipment, and the user belong to the same organization. Another difference to the arrangement shown in FIG. 1 is that the remote terminal has a direct interface to the Internet. Naturally, its connection can be implemented also through a local area network as in FIG. 1 or wirelessly through a node in a mobile communication network.

If the expertise of the user in a problem situation is not sufficient for using the maintenance program MPR, he informs an expert of the situation, as in the previous example. The expert takes through the network “possession” of the local terminal 203 and executes then the maintenance program from his own terminal 205. In this way it can be done, which is possible by program means, so that the expert does not need to travel on the spot.

FIG. 3 shows as a flow diagram an example of the method according to the invention. A problem concerning the operation equipment has been found in step 301, for which reason it is informed about the situation an expert of the software of the operation equipment in question. In step 302 a network connection between the operation equipment and remote terminal, which is in use for an expert, is established through the Internet. If the arrangement comprises a server, which is used for the maintenance of the operation equipment and located in a third place, a network connection from the remote terminal is established also to it. In step 303 the maintenance program of the operation equipment in question is started, and the execution of this program begins. The execution involves transferring the necessary data related to the operating state of the operation equipment from it to the remote terminal (step 304). The content of the data depends on the choice of the expert, and it can be a part of the program code of the operation equipment or values of the use parameters, which are included in the program. In step 305 the expert processes the data making to it changes at his discretion. In step 306 the changed data is transferred back to the operation equipment, and in step 307 it is checked, whether the operation equipment functions as it should. The check can be done by the expert from his own terminal or the user directly with the operation equipment. If the operation equipment does not function right, it is returned to step 304, and the processing of the program data of the operation equipment is continued. When the operation equipment functions as it should, the maintenance action is finished and the network connection(s) are released.

Delivering by the maintenance program data from the operation equipment to the expert congruent to his choice, carrying out the processing and delivering the processed data back to the original place in the operation equipment is the part of the method in accordance with the invention.

A system according to the invention has been described above. It can naturally vary in detail from what is described. For example, the user interface may comprise only a couple of control switches or there is only a connector in the operation equipment to connect e.g. a computer for the external control and/or monitoring. Said actions, as loading the software of the operation equipment and setting the use parameters including in that software, can also be done when a new operation equipment is taken into use. In this description and claims the term ‘maintenance’ then encompasses also the taking into use. The inventive idea can be applied in different ways within the limits set by the independent claims 1 and 9.

1. An arrangement for maintaining remotely an electric operation equipment (101; 201), which arrangement comprises, in addition to the operation equipment, a remote terminal (105; 205) with an Internet connection in use for an expert and a local terminal (103; 203) to be connected to to the operation equipment, which has means to establish a wireless Internet connection and transmission programs to transfer data both between the local terminal and operation equipment and between the local terminal and remote terminal, which operation equipment comprises a software with use parameters, characterized in that the local terminal (103; 203) is a portable device to be arranged to operating state by a user, and the arrangement comprises a maintenance program (MPR) for program-based treatment of the operation equipment performed by the expert.

2. An arrangement according to claim 1, characterized in that said maintenance program is located in the remote terminal (105).

3. An arrangement according to claim 1, characterized in that said maintenance program is located in the local terminal (203), in which case the remote terminal comprises means for taking possession of the software of the local terminal and thus for executing the maintenance program, or treating the data related to a operating state of the operation equipment, in the local terminal through said network connection.

4. An arrangement according to claim 1, characterized in that the operation equipment (101; 201) comprises a user interface with a relatively simple keyboard and display for normal use actions.

5. An arrangement according to claim 1, characterized in that the operation equipment comprises for normal use actions only some control switches or a connector for an external control device.

6. An arrangement according to claim 1, characterized in that it further comprises a server (104) provided with Internet interface, the server containing data and/or software, which relates to the maintenance of the operation equipment in question, to be used for the expert.

7. An arrangement according to claim 6, characterized in that said server (104) is connected to the same local area network (LAN) as the remote terminal (105).

8. An arrangement according to claim 6, characterized in that said server is located in a third place in respect of the remote terminal and local terminal.

9. A method for maintaining remotely an electric operation equipment, the method comprising steps:
notifying (301) an expert quarter of a problem regarding software of the operation equipment
establishing (302) a connection through Internet at least between between the operation equipment and a remote terminal being in use for an expert, and
starting (303) a maintenance program and processing (305) by it data, which relates to an operating state of the operation equipment, characterized in that said notifying to an expert quarter and establishing a Internet connection are performed by a user of the operation equipment, and the method further comprises steps:
transferring (304) the data related to the operating state of the operation equipment and chosen by the expert to the remote terminal for said processing
transferring (306) processed data from the remote terminal to the operation equipment, and
checking (307) whether the operation equipment functions and repeating two preceding steps if not.

10. A method according to claim 9, characterized in that the maintenance program is executed in the remote terminal.

11. A method according to claim 9, characterized in that the maintenance program is executed in the local terminal, and the execution is controlled from the remote terminal through the network connection.

12. A method according to claim 9, characterized in that when executing the maintenance program, or processing data related to the operating state of the operation equipment, values of use parameters in the software of the operation equipment are set.

13. A method according to claim 9, characterized in that when executing the maintenance program, or processing data related to the operating state of the operation equipment, the software of the operation equipment is updated.
